(19) United States
(12) Patent Application Publication
(10) Pub. No.: US 2004/0245214 A1
(43) Pub. Date: Dec. 9, 2004

(54) Electroless plating apparatus and post-electroless plating cleaning method

(76) Inventors: Ichiro Katakabe, Tokyo (JP); Yuki Inoue, Tokyo (JP); Xinming Wang, Tokyo (JP); Daisuke Takagi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/482,310

(22) PCT Filed: Jul. 7, 2003
(86) PCT No.: PCT/JP03/08604

(30) Foreign Application Priority Data
Jul. 5, 2002 (JP) 2002 197684
Jan. 31, 2003 (JP) 2003 24944

(51) Int. Cl. B08B 7/00; B29D 11/00

(52) U.S. Cl. 216/24; 134/6; 134/137; 134/151; 216/66

(57) ABSTRACT

There are provided an electroless plating apparatus and a post-electroless plating cleaning method which can remove Co or Ni particles, produced upon electroless plating onto Cu interconnects of an electronic circuit substrate and remaining on a silicon oxide film as an interlevel dielectric, without exerting an adverse influence on the Cu interconnects. The electroless plating apparatus for carrying out electroless plating of the surface of interconnects formed in a surface of an electronic circuit substrate having fine circuit patterns of conductive metal interconnects, includes: a substrate transfer device (62, 76, 86); a loading station (58) disposed in association with the substrate transfer device; at least one electroless plating cell (82) disposed in association with the substrate transfer device; and a scrub cleaning device (66a) and/or a solution cleaning device (66c) disposed in association with the substrate transfer device.

### TECHNICAL FIELD

The present invention relates to an electroless plating apparatus and a post-electroless plating cleaning method useful for the production of electronic circuit devices. More specifically, the present invention relates to an apparatus for carrying out a so-called electroless cap plating which, in a process for forming interconnects in a substrate to produce a semiconductor device, deposits a different kind of metal from the interconnect metal on the surface of the metal interconnects, and to a method for cleaning the substrate after the electroless plating. In particular, the present invention relates to an electroless plating apparatus for carrying out electroless plating (electroless cap plating) of the surface of copper (Cu) interconnects of a substrate by using an alloy plating bath, such as a cobalt (Co) alloy or a nickel (Ni) alloy, and to a post-electroless plating cleaning method for cleaning the substrate after the electroless plating.

### BACKGROUND ART

In the production of semiconductor devices, aluminum (Al) or an Al alloy has conventionally been employed as an interconnect material for forming interconnects in a semiconductor substrate. With the recent movement toward finer interconnect pitches associated with higher integration of LSI, various problems have become eminent with the conventional Al or Al alloy interconnects, such as delay in signal transmission, electromigration of interconnects, etc., leading to a lowering of reliability of interconnects. It is therefore a current trend to use, instead of Al, a metal having a higher electric conductively, especially copper (Cu), as an interconnect material.

In the case where copper or the like is used as an interconnect material, a silicon nitride film having a high dielectric constant is generally superimposed as a diffusion preventing film on the interconnects. The silicon nitride film, however, adversely affects the reduction of interconnection delay by the use of copper or the like.

In view of this problem, an attempt is now made to use, instead of a silicon nitride film, a film of a Co alloy or a Ni alloy, which is excellent in reduction of interconnection delay, as a diffusion preventing film to be superimposed on Cu interconnects. In this connection, a selective cap plating method is presently being studied which can form by electroless plating a Co alloy or Ni alloy film only on the surface of fine Cu interconnects provided in a substrate.

FIGS. 14A through 14C illustrate, in a sequence of process steps, an example for forming interconnects made of copper by plating a surface of a substrate, thereafter forming a protective film as a diffusion preventing film on the interconnects selectively by electroless plating for protecting the interconnects.

In the semiconductor substrate W, as shown in FIG. 14A, an oxide film 102 of SiO₂ is deposited on a conductive layer 101a of a substrate 101 on which semiconductor devices are formed. Contact holes 103 and trenches 104 for interconnects are formed in the oxide film 102 by the lithography/etching technology. Thereafter, a barrier layer 105 of TiN or the like is formed on the entire surface, and a seed layer 107 as an electric supply layer for electroplating is formed on the barrier layer 105.

Then, as shown in FIG. 14B, copper plating is performed onto the surface of the substrate W to fill the contact holes 103 and the trenches 104 of the substrate W with copper and, at the same time, deposit a copper film 106 on the oxide film 102. Thereafter, the copper film 106 and the seed layer 107 on the oxide film 102 are removed by chemical mechanical polishing (CMP) to make the surface of the copper film 106, filled into the contact holes 103 and the trenches 104 for interconnects, flush with the surface of the oxide film 102. Interconnects composed of copper film 106 are thus formed.

Then, a protective film 108 of a Co alloy or a Ni alloy is formed on the surface of the copper interconnects 106 by electroless cap plating, shown in FIG. 14C.

Such an electroless cap plating, however, involves the problem that an effective method for cleaning the substrate after the electroless cap plating is not developed yet. In this regard, electroless plating of the surface of Cu interconnects with a Co alloy or a Ni alloy to cap the interconnects is carried out by immersing the substrate in a plating bath. Though the Co alloy or Ni alloy is desirably plated only on the Cu interconnects, the alloy inevitably deposits around particles as nuclei or seeds, which particles may be those which have been adhering from pre-processing on the surface of an oxide film as an interlevel dielectric, e.g. copper oxide particles, or those which are present in air or in the plating bath, and the deposited alloy remains on the substrate surface as metal particles.

Such metal particles, remaining on the surface of the oxide film, can short the interconnects and, in addition, they lower the yield.

It is, therefore, demanded to develop a technology which can remove Co or Ni particles, produced upon electroless plating onto Cu interconnects of an electronic circuit substrate and remaining on a silicon oxide film as an interlevel dielectric, without exerting an adverse influence on the Cu interconnects. It is therefore an object of the present invention to provide such a technology.

### DISCLOSURE OF INVENTION

It has now been found by the present inventors that the use of a scrub cleaning and/or a solution cleaning as a post-electroless plating cleaning makes it possible to effectively remove particles deriving from electroless plating.

It has also been found that the use of a cleaning liquid with ultrasonic vibration in the scrub cleaning can enhance the cleaning effect. The present invention has been accomplished based on such findings.

Thus, the present invention provides an electroless plating apparatus for carrying out electroless plating of the surface of interconnects formed in a surface of an electronic circuit substrate having fine circuit patterns of conductive metal interconnects, comprising: a substrate transfer device; a loading station disposed in association with the substrate transfer device; at least one electroless plating cell disposed in association with the substrate transfer device; and a scrub cleaning device and/or a solution cleaning device disposed in association with the substrate transfer device.

In a preferred embodiment of the electroless plating apparatus, the scrub cleaning device and/or the solution cleaning device includes a mechanism for holding and rotating the substrate, and at least one nozzle for supplying a cleaning liquid to a front surface and/or a back surface of the substrate.

The present invention also provides a post-electroless plating cleaning method comprising cleaning an electronic circuit substrate having fine circuit patterns of conductive metal interconnects by scrub cleaning and/or solution cleaning after carrying out electroless cap plating of the surface of the conductive metal interconnects.

In a preferred embodiment of the post-electroless cleaning method, the scrub cleaning is carried out by scrubbing the substrate with a cleaning member which is parallel with the substrate plane and/or a cleaning member rotating horizontally.

In the case where the scrub cleaning is carried out with a horizontally rotating cleaning member, it is preferred to carry out an additional cleaning by jetting a liquid with ultrasonic vibration to the substrate.

In a preferred embodiment, the solution cleaning is carried out by rotating the substrate while supplying a solution, which can preferentially dissolve the interconnect material rather than the electroless cap plating film, to the front surface and/or the back surface of the substrate.

The present invention also provides a substrate cleaning apparatus comprising a combination of: a cleaning device including a plurality of rotators for supporting and rotationally driving the periphery of a substrate to be cleaned, and a cylindrical cleaning member capable of rotating about its axe which is parallel with the substrate plane to scrub clean a to-be-cleaned surface of the substrate; and a cleaning device including a spin chuck capable of rotating horizontally while holding the substrate, and a cleaning member mounted to the front end of a pivot arm and capable of rotating horizontally to scrub clean a to-be-cleaned surface of the substrate held by the spin chuck.

### BRIEF DESCRIPTION OF DRAWINGS

FIG. 1 is a conceptual diagram of a substrate processing apparatus (electroless plating apparatus) according to an embodiment of the present invention;

FIG. 2 is a schematic diagram of a roll cleaning device;

FIG. 3 is a schematic diagram of a pencil cleaning device;

FIG. 4 is a schematic diagram of a pencil cleaning device which utilizes ultrasonic waves;

FIG. 5 is a conceptual diagram of a substrate processing apparatus (electroless plating apparatus) according to another embodiment of the present invention;

FIG. 6 is a diagram illustrating the flow of air in a substrate processing apparatus (electroless plating apparatus) according to yet another embodiment of the present invention;

FIG. 7 is a diagram illustrating the flow of air in the loading/unloading area, the cleaning area and the plating area of the apparatus of FIG. 6;

FIG. 8 is an outline view illustrating the substrate processing apparatus of FIG. 7 as installed in a clean room;

FIG. 9 is a conceptual diagram of a substrate processing apparatus (electroless plating apparatus) according to yet another embodiment of the present invention;

FIG. 10 is a schematic diagram of a solution cleaning device;

FIG. 11 is a schematic diagram of another solution cleaning device;

FIG. 12 is a plan view of a plating apparatus for filling trenches for interconnects with copper;

FIG. 13 is a plan view showing another plating apparatus for filling trenches for interconnects with copper; and

FIGS. 14A through 14C illustrate, in a sequence of process steps, an example for forming interconnects made of copper, thereafter forming a protective film on the interconnects selectively.

### BEST MODE FOR CARRYING OUT THE INVENTION

According to the cleaning method of the present invention, an electronic circuit substrate, having conductive metal interconnects and also having a protective electroless plating film formed on a surface of the interconnects, is subjected to scrub cleaning and/or solution cleaning, thereby removing particles coming from the electroless plating and metal contaminants present between the interconnects, etc.

The conductive metal interconnects, which are in the form of fine circuit patterns, are formed of e.g. copper or a copper alloy, silver or a silver alloy, or gold or a gold alloy. The electroless plating for the formation of the interconnects-protective film may be carried out with a cobalt alloy or a nickel alloy.

The scrub cleaning, employed in the cleaning method of the present invention, is a cleaning method which uses a cleaning member and optionally utilizes a supply of cleaning liquid, and specifically includes a manner of scrubbing the substrate by a cleaning member, typically of a roll shape, which is parallel with the substrate plane (this manner herein being referred to as “roll cleaning”), and a manner of scrubbing the substrate by a cleaning member, typically of a pencil shape, rotating horizontally (this manner herein being referred to as “pencil cleaning”).

The roll cleaning effects cleaning of the substrate by scrubbing the substrate with the circumferential surfaces of a pair of cleaning members, typically rolls, rotating about their own axes which are parallel with the substrate plane, and may be carried out in the following manner: First, the substrate, which has undergone electroless plating with a cobalt alloy or a nickel alloy (hereinafter sometimes referred to as “cap plating”), is transferred to a roll cleaning stage, where the substrate is held by a plurality of rotators (rollers). The rollers start rotating whereby the substrate starts rotating in a certain direction generally at a rotational speed of 10 rpm to 150 rpm.

A pair of rolls of a soft porous material, for example, contacts at their circumferential surfaces to the front and back surfaces of a rotating substrate while the rolls are rotating about their axes that are parallel with the substrate plane. The roll cleaning is carried out in this manner. The soft porous material may be a spongy material, for example, a polyvinyl acetal having fine pores (foamed polyvinyl acetal), a nonwoven fabric settled on a polyurethane, or a foamed polyurethane. The rotational speed of the rolls is generally from 10 rpm to 200 rpm.

During the roll cleaning, a cleaning liquid may be supplied from rinse nozzles to the front and back surfaces of the substrate. The cleaning liquid may be pure water. It is, however, preferred to use a cleaning chemical containing one or more of a surfactant, an organic alkali and a chelating agent in order to carry out cleaning more effectively.

A nonionic surfactant, such as a polyoxyalkylene alkyl ether, for example a polyoxyethylene alkyl ether, is preferably used as the surfactant for the cleaning chemical. The surfactant is used generally in an amount of 0.005 to 3% by weight.

An ammonium salt or an amine may be used as the organic alkali. Specific examples of the ammonium salt include tetramethylammonium hydroxide, tetraethylammonium hydroxide and triethylammonium hydroxide; and examples of the amine include an aliphatic monoamine and an aliphatic polyamine. The organic alkali is used generally in an amount of 0.01 to 2% by weight.

Specific examples of the chelating agent include ethylenediamine tetracetic acid, ethylenediamine diacetic acid, ethylenediamine dipropionic acid, nitrilotripropionic acid, and ethylenediamine ditetrakis acid. The chelating agent is used generally in an amount of not less than 0.0001% by weight.

After completion of the roll cleaning, the roll-shaped cleaning members, which have been in contact with the front and back surfaces of the substrate, are retreated upward and downward. Thereafter, pure water is supplied (jetted) from rinse nozzles disposed above and below to the front and back surfaces of the substrate, thereby rinsing the substrate and removing the cleaning chemical.

The roll cleaning can also be carried out by a cleaning member other than a pair of rolls, e.g. a belt that stretches between two rotating shafts. Almost all the particles on the front and back surfaces of the substrate can be removed by the roll cleaning. Further, by rinsing the cleaning chemical with the pure water during the scrubbing, particles can be prevented from remaining on the surface of the spongy rolls, thereby preventing the particles from being transferred from the rolls to the next substrate to be cleaned.

The pencil cleaning, on the other hand, is a cleaning method in which the substrate is scrubbed with a cleaning member rotating horizontally about its axis perpendicular to the substrate plane.

More specifically, the pencil cleaning may be carried out in the following manner: The substrate is held by a plurality of stage chucks, the number of stage chucks being determined according to the size of the substrate, etc. Next, after raising a cup for prevention of liquid scattering, pure water or a cleaning chemical is supplied (jetted) from nozzles to the front and back surfaces of the substrate. While rotating the substrate at 50-1000 rpm, a pencil arm with a horizontally rotating cleaning member mounted to the front end is moved to a position at which the cleaning member makes contact with the substrate surface. While rotating horizontally, the cleaning member moves on the substrate from end to end and makes one or two reciprocations to carry out scrub cleaning.

The pencil cleaning member, like the above-described roll cleaning member, may be formed of a soft porous material. The rotational speed of the pencil cleaning member is generally 20 to 150 rpm. The moving speed of the arm is generally 5 to 30 mm/sec.

Pure water or a cleaning chemical may be used as a cleaning liquid. When pure water is used as a cleaning liquid, pure water may be supplied (jetted) to the front and back surfaces of the substrate while the cleaning member is scrub cleaning the substrate, e.g. for 7-40 seconds. On the other hand, when a cleaning chemical, for example the same cleaning chemical as used in the roll cleaning, is used as a cleaning liquid, the cleaning chemical may be supplied to the substrate while the cleaning member is scrub cleaning the substrate, e.g. for. 7-40 seconds, and then the substrate may be rinsed with pure water e.g. for 20 seconds or more to rinse off the cleaning chemical.

In carrying out the above-described pencil cleaning, it is preferred to impart ultrasonic vibration to the cleaning liquid and supply (jet) the liquid to the substrate surface. The use of the cleaning liquid with ultrasonic vibration can enhance the cleaning effect. The cleaning with such a cleaning liquid may be carried out either simultaneously with or after the pencil cleaning. The cleaning liquid to which ultrasonic vibration is imparted may either be a cleaning chemical or pure water. The frequency of ultrasonic waves is preferably from 300 kHz to 3 MHz.

The solution cleaning, on the other hand, is a cleaning method which effects cleaning of the substrate by supplying a solution to the surface of the substrate. More specifically, a solution capable of removing a metal is supplied, e.g. by jetting or spraying, to the front surface and/or the back surface of the substrate to clean off particles.

In this solution cleaning, since the conductive metal interconnects are protected by the electroless cap plating film, it is possible to use in the solution cleaning a solution having an ability of dissolving the conductive metal interconnect material. It is preferred to use a solution which can preferentially dissolve the metal interconnect material rather than the electroless plating cap film. The use of such a solution can effectively dissolve and remove metal residues on the substrate remaining in the region other than the circuit patterns covered with the electroless cap plating film.

A solution containing an acid, such as sulfuric acid, hydrochloric acid, hydrofluoric acid, or oxalic acid, and/or a solution containing a chelating agent, such as ammonium ethylenediaminetetracetate, may be used in the solution cleaning. The solution is supplied generally at a rate of 50 to 2000 ml/min. Simultaneously with the supply of the solution, it is possible to carry out scrub cleaning, such as the above-described roll cleaning or pencil cleaning. The solution may be supplied while rotating the substrate. Further, it is possible to supply the solution also to the back surface of the substrate simultaneously with the supply to the front surface. After the solution cleaning, it is preferred to rinse the substrate with pure water.

According to the cleaning method of the present invention, either one of the above-described scrub cleaning, which may be roll cleaning or pencil cleaning, and the solution cleaning may sometimes be sufficient. In most cases, however, it is preferred to carry out the above-described cleanings in combination. Thus, in a preferred embodiment, the roll cleaning or pencil cleaning as the scrub cleaning is first carried out, and then the solution cleaning is carried out. An especially high cleaning effect will be achieved by carrying out the roll cleaning, the pencil cleaning and the solution cleaning sequentially.

After completion of the above-described cleaning, the substrate is rotated, for example, at 1400-2500 rpm for 20-40 seconds to dry the substrate. Though the drying conditions are not particularly limited, the rotational speed of about 2500 rpm and drying time of about 30 seconds may be mentioned as a desirable condition.

By carrying out the cleaning method described hereinabove, fine particles and metal contaminants remaining on the interlevel dielectric (oxide film) between the interconnects of the substrate can be removed efficiently.

A description will now be given of selective formation of the interconnects-protective film (cap material) by electroless plating with a cobalt alloy or a nickel alloy on the fine circuit patterns of a conductive metal, e.g., copper or a copper alloy, silver or a silver alloy, or gold or a gold alloy, formed in the surface of an electronic circuit substrate.

First, the electronic circuit substrate is subjected to a pre-cleaning. The pre-cleaning is carried out by immersing the substrate in an acid solution, such as a 0.5 M H₂SO₄ solution, for example at 25° C. for one minute to remove CMP residues, such as copper, remaining on the surface of the insulating film (oxide film), and then cleaning the surface of the substrate with a cleaning liquid such as ultrapure water.

After the pre-cleaning, the surface of the electronic circuit substrate is subjected to a catalyst-imparting treatment. The catalyst-imparting treatment is carried out by immersing the substrate in e.g. a solution containing 0.005 g/L of PdCl₂ and about 0.7% by weight of HCl, for example at 25° C. for about one minute to adhere Pd as a catalyst to the surface of the interconnects, thereby forming a Pd seed as a catalyst seed on the surface of the interconnects. In association with the catalyst-imparting treatment, a treatment for activating the exposed surface of interconnects or a cleaning treatment with a cleaning liquid, such as ultrapure water may also be carried out.

The surface of the electronic circuit substrate, which has undergone the catalyst-imparting treatment, is further subject to a chemical treatment. The chemical treatment is carried out by immersing the substrate in e.g. a solution of 20 g/L of Na₃C₆H₅O₇.2H₂O (sodium citrate) e.g. at 25° C. to neutralize the surface of the interconnects, and then water-cleaning the substrate surface with e.g. ultrapure water.

Electroless plating of the surface of the electronic circuits substrate may be carried out by using various electroless plating baths, for example, an electroless cobalt alloy plating bath, such as a Co—W—B plating bath or a Co—B plating bath, and an electroless nickel alloy plating bath, such as a Ni—B plating bath or a Ni—W—B plating bath.

The electroless plating can be carried out under the ordinary conditions to a particular bath employed. For instance, when a Co—W—P plating bath is employed, the substrate is immersed in the plating bath at a temperature of about 80° C. e.g. for about 120 seconds to form an electroless plating film (electroless Co—W—P cap plating) selectively on the activated surface of interconnects, and then the surface of the substrate is cleaned with a cleaning liquid such as ultrapure water. The electroless plating film thus formed on the surface of interconnects can selectively protect the interconnects as an interconnects-protective film (cap plating film).

The Co—W—P plating bath, a typical electroless plating bath, generally contains Co ions, a complexing agent, a pH buffer, a pH adjusting agent, an alkylamine borane as a reducing agent, and a tungsten (W)-containing compound.

The cobalt ions in the plating bath may be supplied from a cobalt salt, for example, cobalt sulfate, cobalt chloride or cobalt acetate. The amount of the cobalt ions is generally in the range of 0.001-1.0 mol/L, preferably 0.01-0.3 mol/L.

Specific examples of the complexing agent include carboxylic acids, such as acetic acid, or their salts; oxycarboxylic acids, such as tartaric acid and citric acid, and their salts; and aminocarboxylic acids, such as glycine, and their salts. These compounds may be used either singly or as a mixture of two or more. The total amount of the complexing agent is generally in the range of 0.001-1.5 mol/L, preferably 0.01-1.0 mol/L. Specific examples of the pH 2.5 buffer may include ammonium sulfate, ammonium chloride and boric acid. The pH buffer is used generally in an amount of 0.01 to 1.5 mol/L, preferably 0.1 to 1.0 mol/L.

Specific examples of the pH adjusting agent include ammonia water and tetramethylammonium hydroxide (TMAH). By using the pH adjusting agent, the pH of the plating bath is adjusted generally within the range of 5-14, preferably 6-10. The alkylamine borane as a reducing agent may specifically be dimethylamine borane (DMAB) or diethylamine borane. The reducing agent is used generally in an amount of 0.01 to 1.0 mol/L, preferably 0.01 to 0.5 mol/L.

Examples of the tungsten-containing compound may include tungstic acid or its salts, and heteropoly acids, such as tungstophosphoric acid (e.g. H₃(PW₁₂O₄₀).nH₂O), and their salts. The tungsten-containing compound is used generally in an amount of 0.001 to 1.0 mol/L, preferably 0.01 to 0.1 mol/L.

Besides the above-described compounds, other known additives may be added to the plating bath. Examples of usable additives include a bath stabilizer, which may be a heavy metal compound such as a lead compound, a sulfur compound such as a thiocyanate, or a mixture thereof, and a surfactant of an anionic, cationic or nonionic type. The temperature of the plating bath is generally 30 to 90° C., preferably 40 to 80° C.

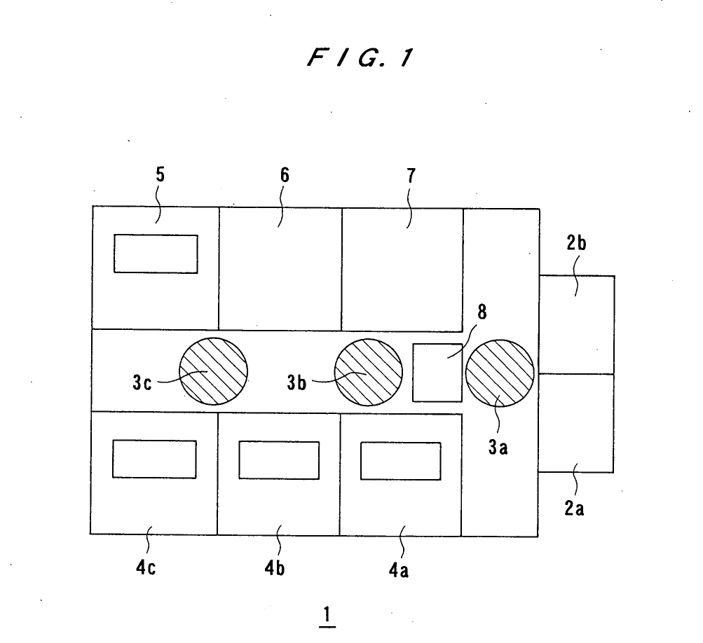

FIG. 1 shows a conceptual diagram of a substrate processing apparatus that can advantageously carry out a cleaning method according to the present invention. The substrate processing apparatus effects cleaning of a substrate by a combination of roll cleaning and pencil cleaning, and comprises cassettes 2a, 2b for storing substrates, pretreatment cells 4a through 4c, a cap plating cell (electroless plating cell) 5, a roll cleaning device 6, a pencil cleaning device 7, a temporary stage 8, and transfer robots 3a through 3c for transferring the substrate between these equipments. According to the apparatus, an electronic circuit substrate, which has undergone chemical mechanical polishing (CMP), is transferred by the transfer robot 3a from the cassette 2a to the pretreatment cell 4a. After carrying out pretreatment in the cell 4a, the substrate is transferred to the pretreatment cell 4b and then to the pretreatment cell 4c to carry out the respective treatments. After the pretreatments, the substrate is transferred to the cap plating cell 5 to carry out electroless cap plating with a cobalt alloy or a nickel alloy.

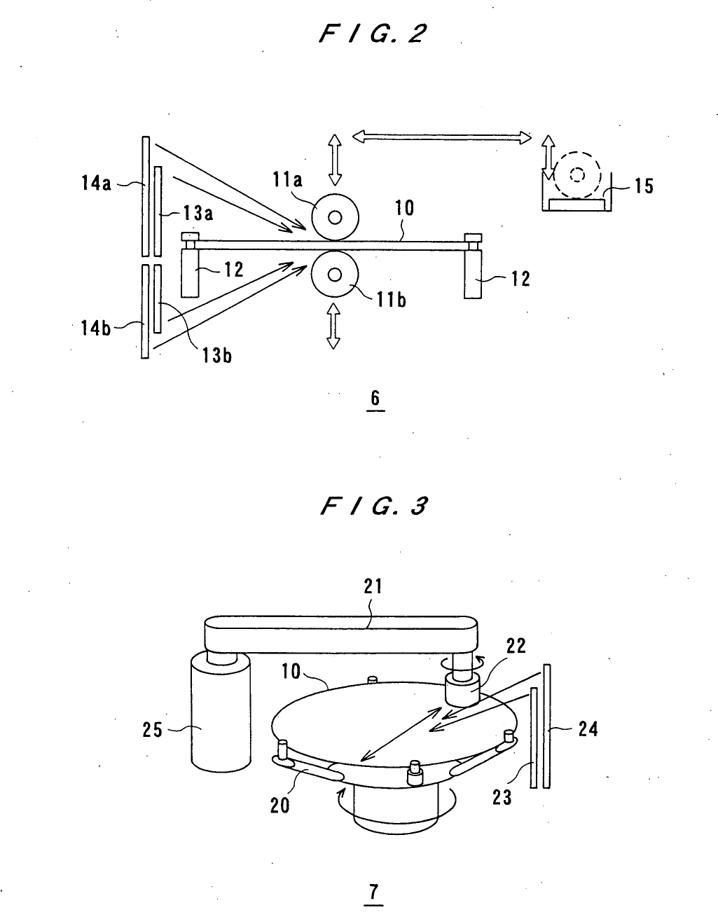

The substrate after the cap plating is transferred by the transfer robot 3c to the roll cleaning device 6 to carry out roll cleaning. FIG. 2 is a schematic diagram of the roll cleaning device 6. As shown in FIG. 2, the substrate 10 to be cleaned is supported by a plurality of rotators (rollers) 12 that rotationally drive the periphery of the substrate 10. The front and back surfaces of the substrate 10 are scrub-cleaned by a pair of cylindrical cleaning members 11a, 11b rotating about their axes that are parallel with the substrate plane. In the cleaning, a cleaning chemical is jetted from cleaning chemical nozzles 13a, 13b and pure water is jetted from pure water nozzles 14a, 14b.

After the roll cleaning, the substrate 10 is transferred by the robot 3b to the pencil cleaning device 7 to carry out pencil cleaning. FIG. 3 is a schematic diagram of the pencil cleaning device 7. According to this device, the substrate 10 to be cleaned is held by spin chucks 20 so that the substrate can rotate horizontally. While rotating the substrate 10, a cleaning member 22, which is mounted to the front end of a pivot arm 21 and is rotating horizontally, is brought into contact with the substrate 10 to carry out scrub cleaning. By the rotation of the spin chucks 20 and the movement of the pivot arm 21, the whole surface of the substrate 10 can be cleaned. As with the roll cleaning device 6, a necessary cleaning chemical is jetted from a cleaning chemical nozzle 23 and pure water is jetted from a pure water nozzle 24.

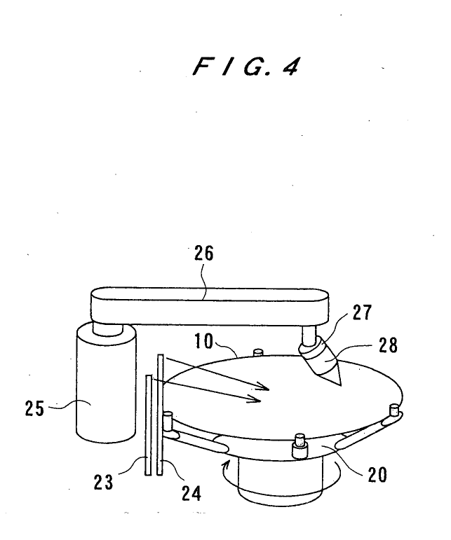

With respect to the pencil cleaning device, as shown in FIG. 4, it is possible to provide a nozzle 28 having an ultrasonic transducer 27 at the front end of a pivot arm 26 so that a liquid with ultrasonic vibration can be jetted from the nozzle 28 to the surface of the substrate 10. Alternatively, as shown in FIG. 11, it is also possible not to use the pivot arm, and provide nozzle 32 for supplying a chemical liquid to the front surface of the substrate and nozzles 33, 34 for supplying pure water and a chemical liquid to the back surface of the surface of the substrate, so that the necessary chemical liquid can be jetted to the substrate to remove a slight amount of metal residues.

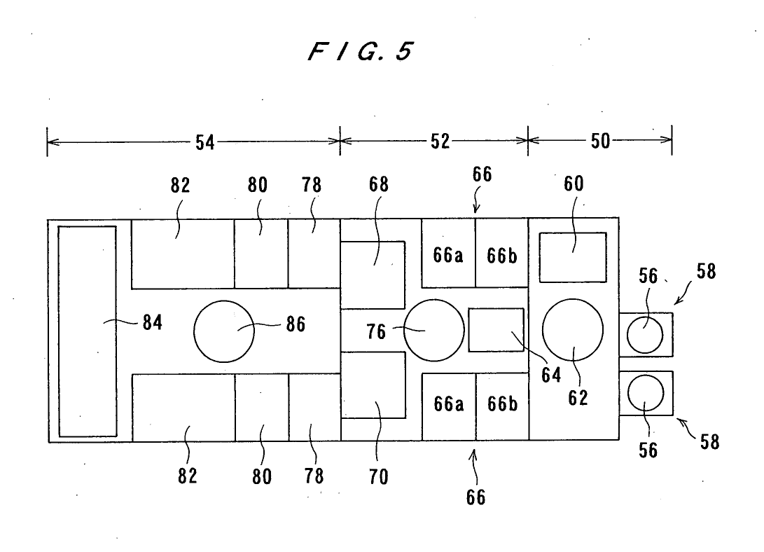

FIG. 5 is a conceptual diagram of a substrate processing apparatus (electroless plating apparatus) that can advantageously carry out a cleaning method according to another embodiment of the present invention, illustrating a layout plan of the apparatus in which a cleaning apparatus according to the present invention is incorporated. As shown in FIG. 5, the substrate processing apparatus is divided into three areas: a loading/unloading area 50, a cleaning area 52 and a plating area 54.

The substrate processing apparatus (electroless plating apparatus) is installed in a clean room, and the pressures in the respective areas are set as follows:

pressure in loading/unloading area 50>pressure in cleaning area 52>pressure in plating area 54.

Further, the pressure in the loading/unloading area 50 is set to be lower than the pressure in the clean room. This prevents air flowing from the plating area 54 into the cleaning area 52, prevents air flowing from the cleaning area 52 into the loading/unloading area 50, and also prevents air flowing from the loading/unloading area 50 into the clean room.

In the loading/unloading area 50, there are provided two loading/unloading units 58 each for placing thereon and housing a substrate cassette 56 that houses a substrate having interconnects formed in interconnect trenches formed in the surface, a first reversing machine 60 for reversing the substrate 180 degrees, and a first transfer robot 62 for transferring the substrate between the substrate cassette 56, the first reversing machine 60 and the below-described temporary stage 64.

In the cleaning area 52, there are provided a temporary stage 64 positioned on the loading/unloading area 50 side, two cleaning apparatuses 66 according to the present invention for cleaning the substrate after cap plating, positioned on both sides of the temporary stage 64, a pre-cleaning device 68 for pre-cleaning the substrate before cap placing and a second reversing machine 70 for reversing the substrate 180 degrees., both positioned on the plating area 54 side. The cleaning apparatus 66 according to the present invention comprises a roll cleaning device 66a and a pencil cleaning device 66b which carry out two-step cleaning and spin-drying of the substrate after plating. Further, a second transfer robot 76 is disposed in the center of the temporary stage 64, the two cleaning apparatuses 66, the pre-cleaning device 68 and the second reversing machine 70 for transfer of the substrate therebetween.

In the plating area 54, there are provided pairs of first pretreatment units 78 for carrying out a catalyst-imparting treatment of the (front) surface of the substrate, second pretreatment units 80 for carrying out a chemical treatment of the catalyst-imparted surface of the substrate, and electless plating units 82 for carrying out electroless plating of the surface of the substrate, each pair being disposed in parallel. Further, a plating solution supply device 84 is disposed at one end of the plating area 54. Furthermore, a movable third transfer robot 86 is disposed in the center of the plating area 54 for transfer of the substrate between the pre-cleaning device 68, the first pretreatment unit 78, the second pretreatment unit 80, the electroless plating unit 82 and the second reversing machine 70.

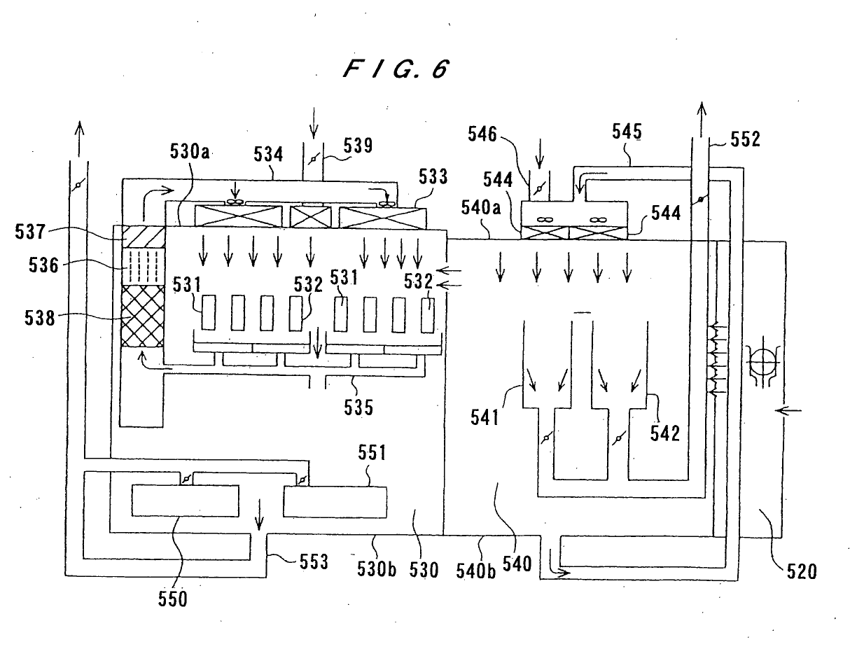

FIG. 6 is a diagram illustrating the flow of air in a substrate processing apparatus (electroless plating apparatus) according to yet another embodiment of the present invention. In a cleaning area 540, fresh external air is taken in from a pipe 546, and the air is forced into the cleaning area 540 by a fan through a high-performance filter 544 and supplied as a down-flow clear air from a ceiling 540a to around a water-cleaning section 541 and a drying section 542. Most of the clean air supplied is returned from a floor 540b through a circulation pipe 545 to the ceiling 540a side, and forced again by the fan into the cleaning area 540 through the high-performance filter 544. The air is thus circulated. Part of the air is discharged from the water-cleaning section 541 and the drying section 542 through a duct 552.

With respect to a plating area 530, though it is a wet zone, adhesion of particles to the surface of a semiconductor wafer must be avoided. According to this embodiment, air is forced through a high-performance filter 533 by a fan into the plating area 530, so that a down-flow clean air is supplied from a ceiling 530a into the plating area 530, thereby preventing particles from adhering to the surface of a semiconductor wafer.

If all of the clean air is supplied from external air, it becomes necessary to take in and discharge an enormous amount of air. In this embodiment, therefore, only such an amount of air is discharged from a duct 553 that is necessary to keep the plating area 530 at a negative pressure, and most of the clean air is circulated through pipes 534, 535.

The circulating air, which has passed the plating area 530, contains a chemical mist or vapor. Accordingly, the circulating air is passed through a scrubber 536 and mist separators 537, 538 to remove such an impurity. The circulating air, which has returned to the circulation duct 534 on the ceiling 530a side and which is free of the chemical mist or vapor, is again forced through the high-performance filter 533 by the fan into the plating area 530 as a down-flow clean air.

Part of the air, which has passed the plating area 530 and contains a chemical mist or vapor, is discharged from a floor 530b through the duct 553. Fresh air is supplied from a duct 539 on the ceiling 530a in such an amount that meets the amount of air discharged and keeps the plating area 530 at a negative pressure.

As with the apparatus of FIG. 5, the pressures in the respective areas are set as follows:

pressure in loading/unloading area 520>pressure in cleaning area 540>pressure in plating area 530

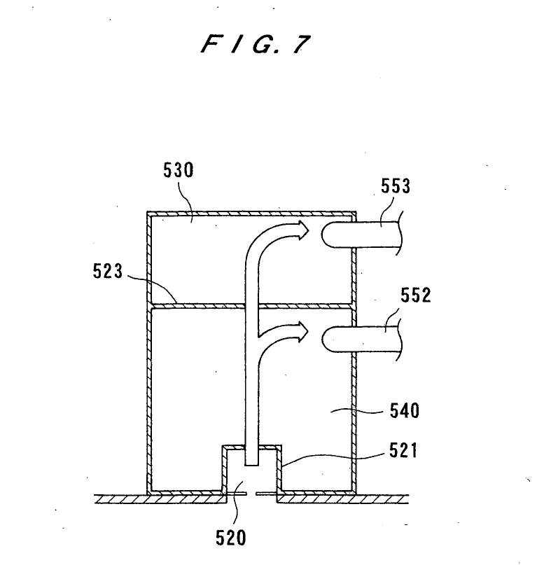

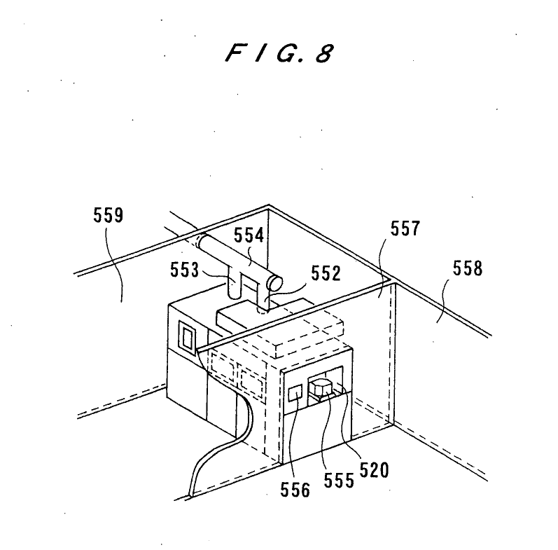

Accordingly, when shutters are opened, air flows from the loading/unloading area 520 to the cleaning area 540, and then to the plating area 530, as shown in FIG. 7. The discharged air is passed through the ducts 552, 553 and corrected in a collecting air discharge duct 554, as shown in FIG. 8.

FIG. 8 is an outline view illustrating the substrate processing apparatus of FIG. 7 as installed in a clean room. As shown in FIG. 8, a side wall of the loading/unloading area 520, having a cassette carry-in-and-out opening 555 and an operation panel 556, is exposed to a working zone 558 with a high cleanness which is partitioned by a partition wall 557 in the clean room, while the other side walls are housed in a utility zone 559 with a low cleanness.

According to the substrate processing apparatus shown in FIGS. 6 through 8, the cleaning area 540 is disposed between the loading/unloading area 520 and the plating area 53b, and partition walls 521, 523 are provided respectively between the loading/unloading area 520 and the cleaning area 540, and between the cleaning area 540 and the plating area 530. Accordingly, a semiconductor wafer, which is carried in a dry state from the working zone 558 into the substrate processing apparatus through the cassette carry-in-and-out opening 555, after undergoing plating in the apparatus, can be carried out to the working zone 558 in a cleaned and dried state.

A series of electroless plating processing will now be described, taking the electroless plating apparatus of FIG. 5 as an example. In the below-described embodiment, an interconnects-protective film (cap material) of a Co—W—P alloy film is formed selectively on interconnects to protect the interconnects.

First, a substrate having interconnects formed in the surface is taken by the first transfer robot 62 out of the substrate cassette 56 placed on the loading/unloading unit 58 and housing substrates with their front surfaces facing upward. The substrate is transferred to the first reversing machine 60, where the substrate is reversed so that its front surface faces downward, and then the substrate is transferred onto the temporary stage 64. The substrate placed on the temporary stage 64 is then transferred by the second transfer robot 76 to the pre-cleaning device 68.

In the pre-cleaning device 68, the substrate is held with its front surface facing downward and the following pre-cleaning is carried out to the surface of the substrate. The substrate is immersed in an acid solution, such as a 0.5 M H₂SO₄ solution, for example at 25° C. for one minute to remove CMP residues, such as copper, remaining on an insulating film. Thereafter, the surface of the substrate is cleaned with a cleaning liquid such as ultrapure water.

Next, the substrate after the pre-cleaning is transferred by the third transfer robot 86 to the first pretreatment unit 78, where the substrate is held with its front surface facing downward and a catalyst-imparting treatment of the surface is carried out. The catalyst-imparting treatment is carried out by immersing the substrate in e.g. a solution containing 0.005 g/L of PdCl₂ and about 0.7% by weight of HCl, for example at 25° C. for about one minute to adhere Pd as a catalyst to the surface of the interconnects, thereby forming a Pd seed as a catalyst seed on the surface of the interconnects. Thereafter, a treatment for activating the exposed surface of interconnects is carried out, and then the surface of the substrate is cleaned with a cleaning liquid such as ultrapure water.

The catalyst-imparted substrate is transferred by the third transfer robot 86 to the second pretreatment unit 80, where the substrate is held with its front surface facing downward and a chemical treatment of the surface of the substrate is carried out. The chemical treatment is carried out by immersing the substrate in e.g. a solution of 20 g/L of Na₃C₆H₅O₇.2H₂O (sodium citrate) e.g. at 25° C. to neutralize the surface of the interconnects, and then water-cleaning the surface of the substrate with e.g. ultrapure water.

The substrate, which has undergone the pre-electroless plating treatments, is transferred by the third transfer robot 86 to the electroless plating unit 82, where the substrate is held with its front surface facing downward and electroless plating of the surface of the substrate is carried out. The electroless plating is carried out, for example, by immersing the substrate in a Co—W—P plating bath at a temperature of about 80° C. e.g. for about 120 seconds to form an electroless plating film (electroless Co—W—P cap plating) selectively on the activated surface of interconnects, and then cleaning the surface of the substrate with a cleaning liquid such as ultrapure water. An interconnects-protective film (cap plating film) composed of Co—W—P alloy film thus formed selectively on the surface of the interconnects can protect the interconnects.

Next, the substrate after the electroless plating is transferred by the third transfer robot 86 to the second reversing machine 70, where the substrate is reversed so that its front surface faces upward. The reversed substrate is transferred by the second transfer robot 76 to the roll cleaning device 66a of the cleaning apparatus 66 according to the present invention, where particles or unnecessary matters adhering to the surface of the substrate are removed by roll-shaped brushes. Thereafter, the substrate is transferred by the second transfer robot 76 to the pencil cleaning device 66b of the cleaning apparatus 66, where chemical cleaning and/or pure water cleaning of the surface of the substrate is carried out, and the cleaned substrate is spin-dried.

The dried substrate is transferred by the second transfer robot 76 onto the temporary stage 64, and the substrate placed on the temporary stage 64 is returned by the first transfer robot 62 to the cassette 56 placed on the loading/unloading unit 58.

Though in this embodiment a Co—W—B alloy film is employ for the interconnects-protective film, the film is not limited to such an alloy, and may be formed of some other alloy such as Co—B, Ni—B or Ni—W—B. Further, besides copper, a copper alloy, silver or a silver alloy, or gold or a gold alloy may be used as an interconnect material.

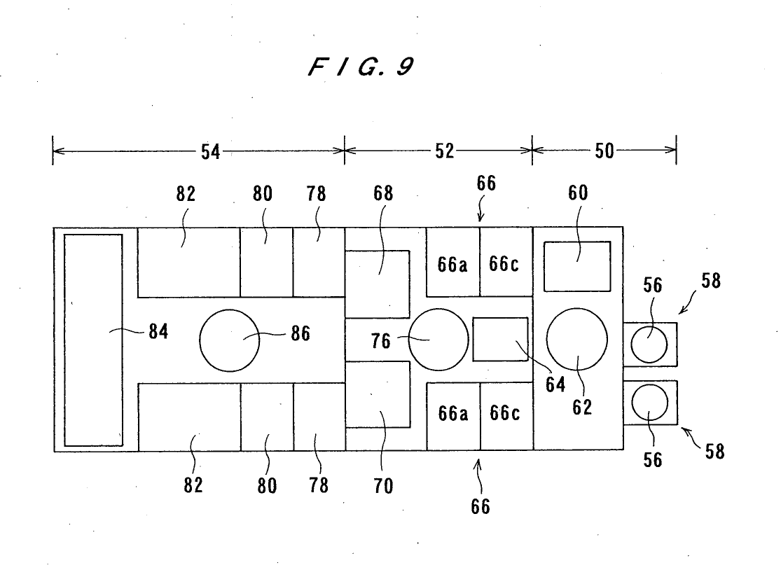

FIG. 9 shows a layout plan of a substrate processing apparatus (electroless plating apparatus) incorporating a cleaning apparatus according to another embodiment of the present invention. The substrate processing apparatus of this embodiment has the same construction as the above-described substrate processing apparatus of FIG. 5 except that the cleaning apparatus 66 consists of the roll cleaning device 66a and a solution cleaning device 66c.

According to the substrate processing apparatus of this embodiment, after removing particles or unnecessary matters from the substrate by the roll cleaning device 66a, the substrate is transferred by the second transfer robot 76 to the solution cleaning device 66c, where the surface of the substrate is subjected to solution cleaning and pure water cleaning, followed by spin-drying.

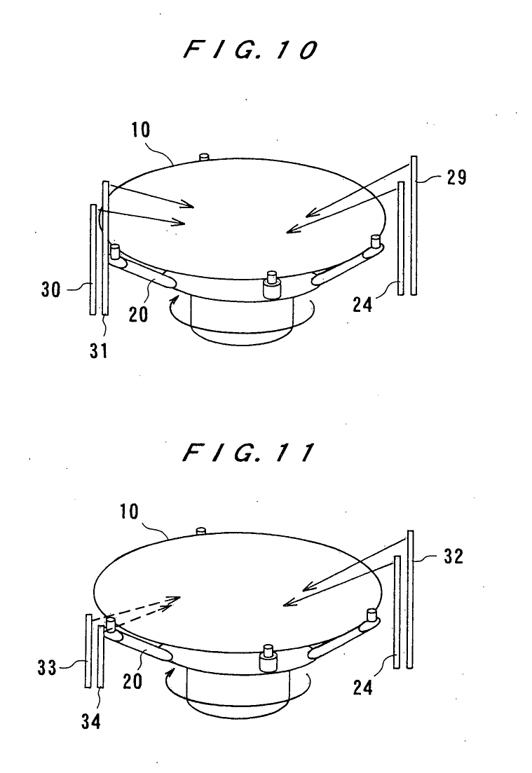

FIG. 10 schematically shows a spin-cleaning unit for use in the solution cleaning device 66c. According to this device, a substrate 10 as a cleaning object is held by spin chucks 20 and rotates horizontally. A solution is supplied from nozzles 29, 30 to the center of the substrate. Since the substrate is rotating, the solution spreads over the entire surface of the substrate, so that the entire surface can be cleaned. After supplying the solution from the nozzles 29, 30 for an arbitrary period of time, pure water is supplied from nozzles 24, 31 to the center of the substrate to rinse off the solution. After rinsing off the solution, the rotation of the substrate is stopped, and the supply of pure water from the nozzles 24, 31 is stopped. The substrate is then transferred to a not-shown spin-drying unit to spin dry the substrate. Thereafter, the spin-dried substrate is transferred by the second transfer robot 76 of FIG. 9 onto the temporary stage 64. The substrate placed on the temporary stage 64 is returned by the first transfer robot 62 to the substrate cassette 56 placed on the loading/unloading unit 58.

The spin-cleaning unit may also serve as a spin-drying unit, so that drying of the substrate can be carried out in the spin-cleaning unit. In that case, the above-described separate spin-drying unit is no longer needed.

FIG. 12 is a plan view of a plating apparatus for filling contact holes and trenches for interconnects with copper. The plating apparatus comprises loading/unloading sections 610, each pair of cleaning/drying sections 612, first substrate stages 614, bevel-etching/chemical cleaning sections 616 and second substrate stages 618, a washing section 620 provided with a mechanism for reversing the substrate through 1800, and four plating sections 622. The plating apparatus is also provided with a first transferring device 624 for transferring a substrate between the loading/unloading sections 610, the cleaning/drying sections 612 and the first substrate stages 614, a second transferring device 626 for transferring a substrate between the first substrate stages 614, the bevel-etching/chemical cleaning sections 616 and the second substrate stages 618, and a third transferring device 628 for transferring the substrate between the second substrate stages 618, the washing section 620 and the plating sections 622.

The plating apparatus has a partition wall 711 for dividing the plating apparatus into a plating space 712 and a clean space 713. Air can individually be supplied into and exhausted from each of the plating space 712 and the clean space 713. The partition wall 711 has a shutter (not shown) capable of opening and closing. The pressure of the clean space 713 is lower than the atmospheric pressure and higher than the pressure of the plating space 712. This can prevent the air in the clean space 713 from flowing out of the plating apparatus and can prevent the air in the plating space 712 from flowing into the clean space 713.

According to this apparatus, of the four plating sections 622 as shown in FIG. 12, one is employed as a first plating section 622a for a first-stage plating and the other three are employed as second plating sections 622b for second-stage plating.

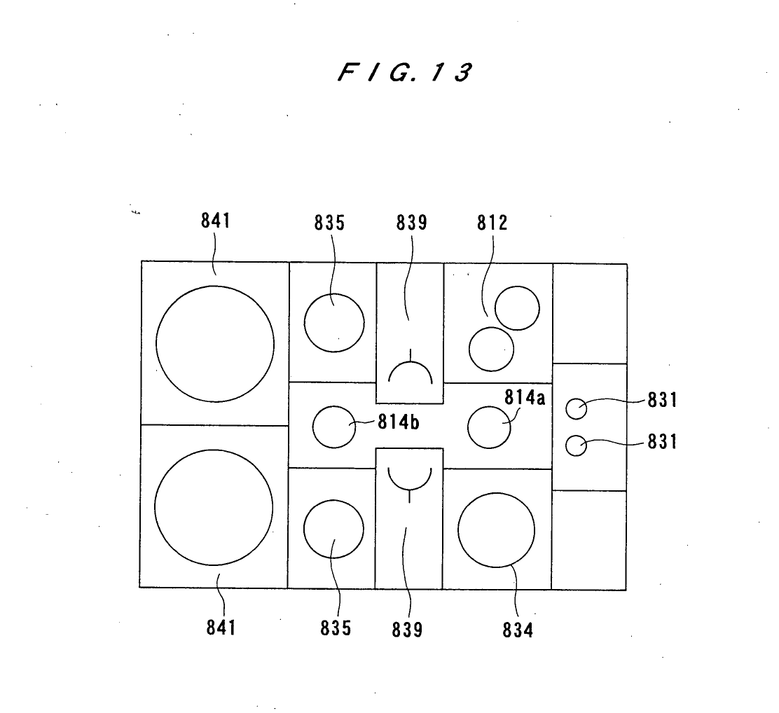

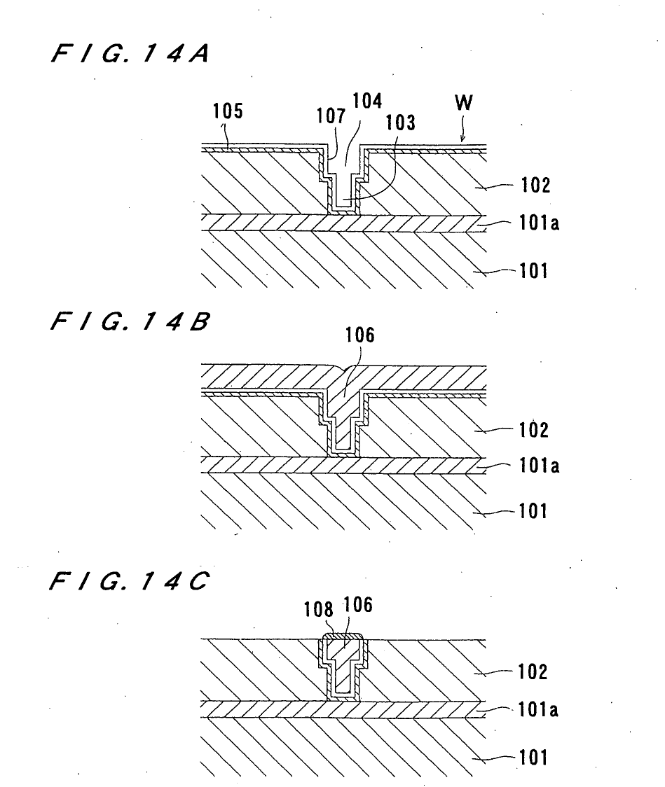

The flow of the substrate is, for example, as follows: First, the substrate having a seed layer 107 (see FIG. 14A) as an outer layer is taken one by one from the loading/unloading section 610 by the first transferring device 624, and is transferred, via the first substrate stage 614 and the second substrate stage 618, to the first plating section 622a.

Next, the first-stage plating is carried out in the first plating section 622a, using the first plating solution, thereby reinforcing and completing the thin portion of the seed layer 107.

After the completion of the first-stage plating, the substrate is, according to necessity, transferred to the washing section 620 for washing by water, and is then transferred to one of the second plating sections 622b.

Next, the second-stage plating is performed onto the surface of the substrate in the second plating section 622b, using a copper sulfate plating solution (second plating solution) having an excellent leveling property, thereby effecting filling with copper. Since the seed layer 107 (see FIG. 14A) has been reinforced by the first-stage plating to become a complete layer without a thin portion, electric current flows evenly through the seed layer 107 in the second-stage plating, whereby the filling with copper can be completed without the formation of any voids.

After the completion of the second-stage plating, the substrate is, according to necessity, transferred to the washing section 620 for washing by water. Thereafter, the substrate is transferred to the bevel-etching/chemical cleaning section 616 where the substrate is cleaned by using a chemical liquid, and a thin copper film, etc. formed on the bevel portion of the substrate is etched away. The substrate is then transferred to the cleaning/drying section 612 for cleaning and drying. Thereafter, the substrate is returned to the cassette of the loading/unloading section 610 by the first transferring device 624.

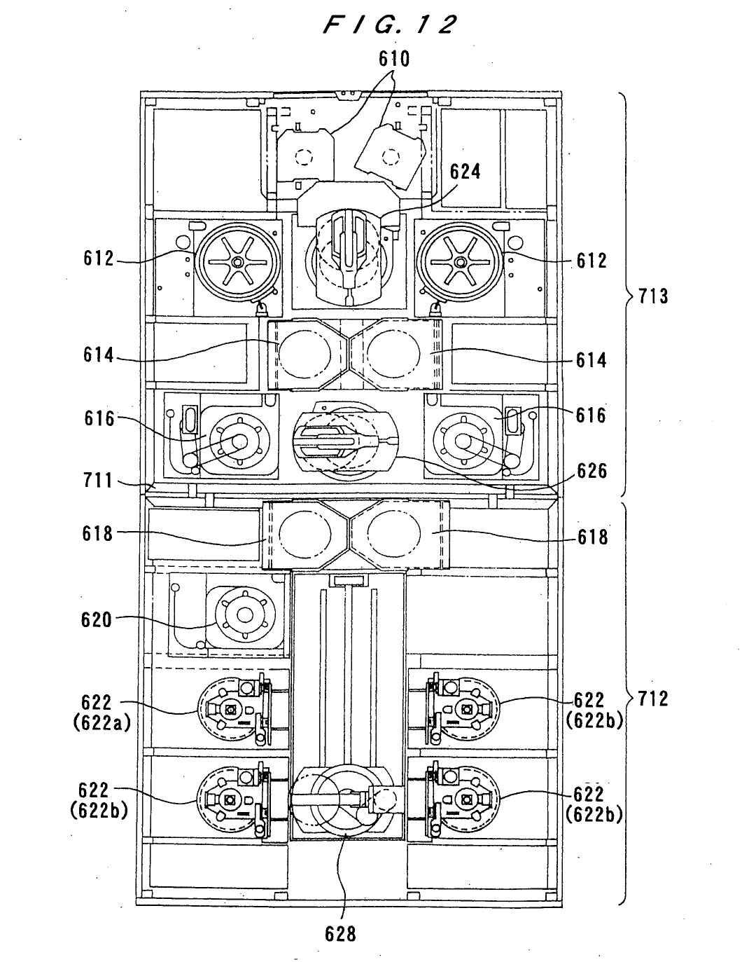

FIG. 13 is a plan view showing another plating apparatus which includes polishing units integrally so that a surface of a substrate can be polished immediately after plating. This plating apparatus comprises substrate cassettes 831, 831 for loading and unloading, plating section 812, cleaning sections 835, 835 for cleaning substrates, two transferring devices 814a, 814b, reversing machines 839, 839, and polishing units 841, 841, and spin dryer 834.

The flow of a substrate is, for example, as follows: First, the transferring device 814a withdraws the substrate before treatment from one of the substrate cassettes 831 for loading. After plating treatment is performed by the plating section 812, the transferring device 814a transfers the substrate to one of the reversing machines 839, which directs its treated surface facing downward. Then, the substrate is transferred to the other transferring device 814b. The transferring device 814b transfers the substrate to one of the polishing units 841 in which predetermined polishing is performed. The substrate after polishing is withdrawn by the transferring device 814b, and cleaned by one of the cleaning sections 835. Then, the substrate is transferred to the other polishing unit 841 where it is polished again, and the substrate is transferred by the transferring device 814b to the other cleaning section 835 where it is cleaned. The substrate after cleaning is transferred by the transferring device 814b to the other reversing machine 839 where its treated surface is turned over to face upward. Then, the substrate is transferred by the transferring device 814a to the spin dryer 834 in which spin-drying is carried out, and the substrate W is accommodated again by the transferring device 814a in the substrate cassette 831 for unloading.

The following examples are provided to further illustrate the present invention and are not to be construed as limiting the invention in any manner.

### EXAMPLE 1

An oxide film was formed by CVD on a silicon substrate having a diameter of 20 cm. Next, pattern for interconnects, with a trench width 160 nm and a trench depth 500 nm, was formed in the surface of the substrate. Thereafter, using tantalum/tantalum nitride as a barrier metal, a barrier film was formed on the substrate to prepare a sample substrate.

A Cu seed layer was sputtered onto the sample substrate by a sputtering apparatus. Copper sulfate plating was then carried out to fill the fine trenches with copper. Thereafter, according to the common procedure, a CMP processing was carried out using an alumina-based slurry. Further, cap plating was carried out onto the thus formed copper interconnects using an electroless Co-W—P (cobalt-tungsten-phosphorus) plating bath having the composition shown below. The cap plating was carried out by immersing the sample substrate in the plating bath, kept at 70° C., for one minute.

<Composition of electroless Co—W—P plating bath>

| | |
|---|---|
| Cobalt sulfate | 0.05 mol/l |
| Sodium tungstate | 0.10 mol/l |
| Sodium citrate | 0.30 mol/l |
| Sodium hypophosphite | 0.20 mol/l |
| pH 10 (adjusted with sodium hydroxide) | |

The sample substrate after the cap plating was subjected to scrub cleaning, using pure water or each of the below-described cleaning chemicals A through E as a cleaning liquid. The scrub cleaning was carried out first by a pair of roll-type cleaning members of a porous polyvinyl acetal material (roll diameter: 38 mm, rotating speed: 100 rpm, cleaning time: 60 sec), and then by a pencil-type cleaning member of a porous polyvinyl acetal material (pencil sponge diameter: 30 mm, pencil sponge rotating speed: 60 rpm, substrate rotating speed: 500 rpm, pencil sponge pivoting speed: 20 mm/sec, number of pivoting movement of pencil sponge: one reciprocation of movement from one end of substrate to the other). The sample substrate after the scrub cleaning was dried by rotating it at. 2000 rpm for 30 seconds.

<Composition of Cleaning Chemical>

Cleaning Chemical A:

0.075% aqueous solution of polyoxyalkylene alkyl ether*

Cleaning Chemical B:

0.03% aqueous solution of tetramethylammonium hydroxide

Cleaning Chemical C:

1:1 mixed solution of 0.15% aqueous solution of polyoxyalkylene alkyl ether* and 0.06% aqueous solution of tetramethylammonium hydroxide

Cleaning Chemical D:

1:1 mixed solution of 0.06% aqueous solution of tetramethylammonium hydroxide and 0.002% aqueous solution of ethylenediamine tetraacetic acid (EDTA)

Cleaning Chemical E:

1:1:1 mixed solution of 0.225% aqueous solution of polyoxyalkylene alkyl ether*, 0.09% aqueous solution of tetramethylammonium hydroxide and 0.003% aqueous solution of EDTA

* RO(CH₂CH₂O)₁(CH(CH₃)CH₂O)ₘ(CH₂CH₂O)ₙH

R=C₁₂H₂₅/C₁₄H₂₉ (7:3)

1+n=10, m=4.5

After completion of the cleaning, evaluation of the cleaning was conducted by measuring the number of particles on the substrate using a laser light scattering-type defect detection device with a pattern recognition function, which can detect particles on the order of 0.2 μm. The above-described test was carried out repeatedly three times. The results are shown in Table 1 below.

TABLE 1

| | Number of particles | | |
|---|---|---|---|
| Cleaning conditions | 1 | 2 | 3 |
| Scrub cleaning with pure water | 357 | 289 | 420 |
| Scrub cleaning with cleaning | 24 | 32 | 42 |
| chemical A | | | |
| Scrub cleaning with cleaning | 82 | 59 | 103 |
| chemical B | | | |
| Scrub cleaning with cleaning | 21 | 38 | 17 |
| chemical C | | | |
| Scrub cleaning with cleaning | 12 | 20 | 5 |
| chemical D | | | |
| Scrub cleaning with cleaning | 8 | 12 | 5 |
| chemical E | | | |
| No scrub cleaning | 1650 | 2118 | 1928 |

As apparent from the results shown in Table 1, the scrub cleaning according to the present invention, especially one that uses each of the cleaning chemicals, can effectively remove particles on the oxide film.

### EXAMPLE 2

A silicon oxide film was formed by CVD on a silicon substrate without a pattern for interconnects, having a diameter of 20 cm. Next, a film of barrier metal (tantalum/tantalum nitride) was formed on the silicon substrate by a sputtering apparatus to prepare a sample substrate.

A Cu seed layer was sputtered onto the sample substrate by a sputtering apparatus. A Cu plating film was then formed on the whole surface of the sample by a copper electroplating apparatus. Therefore, according to the common procedure, a CMP processing was carried out using an alumina-based slurry to remove the Cu film and the barrier metal film on the sample substrate, followed by the usual post-CMP treatments. Further, after a catalyst-imparting treatment was carried out with the use of the Pd compound, the sample was immersed in the electroless Co—W—P (cobalt-tungsten-phosphorus) plating bath used in Example 1 for one minute.

Since the Cu film and the barrier metal film should have been removed by the CMP processing and the post-CMP treatments, a cap plating film should not grow. In fact, however, a minute amount of Cu particles or residual Cu contaminant remains unremoved, and a slight amount of cap plating film is formed around such residual copper which acts as a seed.

The sample substrate, which had undergone the common processing for formation of Cu interconnects except for no processing for formation of pattern (no interconnect was therefore formed) and the subsequent cap plating, was subjected to the following cleaning: the same roll scrub cleaning as in Example 1 using pure water or the cleaning chemical A; solution cleaning with an acidic chemical; or the roll scrub cleaning using the cleaning chemical A, followed by the solution cleaning with the acidic chemical.

The roll scrub cleaning was carried out under the same conditions as in Example 1. The acidic chemical used in the solution cleaning was an aqueous solution containing 1.0% by weight of oxalic acid and 0.05% by weight of HF. The solution cleaning was carried out by supplying the acidic chemical to the sample substrate for two minutes while rotating the substrate at 500 rpm. Thereafter, the substrate was rinsed with deionized water for 30 seconds while rotating the substrate at 500 rpm. After the rinsing, the substrate was rotated at 2000 rpm for 30 seconds to dry the substrate.

After completion of the cleaning, metal contaminants on the surface of the sample substrate were eluted and analyzed by means of ICP-MS to compare the residual metal contaminants after the respective cleanings.

TABLE 2

| | Amount of metal contaminants | | |
|---|---|---|---|
| | (×10¹⁰ atoms/cm²) | | |
| Cleaning conditions | Pd | Co | Na |
| Scrub cleaning with pure water | 50 | ≧100 | ≧100 |
| Scrub cleaning with cleaning | ≦1 | 40 | 10 |
| chemical A | | | |
| Solution cleaning with acidic | 70 | ≧100 | ≦1 |
| solution | | | |
| Scrub cleaning with cleaning | ≦1 | ≦1 | ≦1 |
| chemical A & Solution cleaning | | | |
| with acidic solution | | | |

The data in Table 2 shows that only with the scrub cleaning, a slight amount of metal contaminants remains unremoved on the sample substrate though particle contaminants can be removed as shown in Table 1. The solution cleaning alone cannot fully remove large metal particles, leading to the large analytical values shown in Table 2. In contrast, by first carrying out the scrub cleaning and then additionally carrying out the solution cleaning using the chemical which can dissolve the metals, the metal contaminants remaining after the cleaning can be effectively removed.

As described hereinabove, according to the cleaning method of the present invention, particles of cobalt, nickel, etc. deposited on the non-circuit surface of an electronic circuit substrate can be removed almost completely, enabling the formation of a stable copper circuit.

In particular, by carrying out the scrub cleaning and the solution cleaning sequentially, it becomes possible to effectively remove fine particles which have not been removed by the scrub cleaning or metals which have reacted with the surface of an interlevel dielectric film and remain on the film.

### INDUSTRIAL APPLICABILITY

The present invention relates to an apparatus for carrying out a so-called electroless cap plating which, in a process for forming interconnects in a substrate to produce a semiconductor device, deposits a different kind of metal from the interconnect metal on the surface of the metal interconnects, and to a method for cleaning the substrate after the electroless plating.

1. An electroless plating apparatus for carrying out electroless plating of the surface of interconnects formed in a surface of an electronic circuit substrate having fine circuit patterns of conductive metal interconnects, comprising:
a substrate transfer device;
a loading station disposed in association with the substrate transfer device;
at least one electroless plating cell disposed in association with the substrate transfer device; and
a scrub cleaning device and/or a solution cleaning device disposed in association with the substrate transfer device.

2. The electroless plating apparatus according to claim 1, wherein the scrub cleaning device comprises a cleaning device which carries out cleaning of the substrate by scrubbing the substrate with a cleaning member which is parallel with the substrate plane, or a cleaning device which carries out cleaning of the substrate by scrubbing the substrate with a cleaning member rotating horizontally, or a combination of these cleaning devices.

3. The electroless plating apparatus according to claim 1, further comprising at least one pretreatment device disposed in association with the substrate transfer device.

4. The electroless plating apparatus according to claim 3, wherein the pretreatment device comprises a chemical treatment cell and/or a catalyst-imparting cell.

5. The electroless plating apparatus according to claim 1, wherein the scrub cleaning device includes a cleaning member made of a polyvinyl acetal having fine pores (foamed polyvinyl acetal), a nonwoven fabric settled on a polyurethane, or a foamed polyurethane.

6. The electroless plating apparatus according to claim 1, wherein the solution cleaning device includes a mechanism for holding and rotating the substrate, and at least one nozzle for supplying a solution to a front surface and/or a back surface of the substrate.

7. A post-electroless plating cleaning method comprising cleaning an electronic circuit substrate having fine circuit patterns of conductive metal interconnects by scrub cleaning and/or solution cleaning after carrying out electroless cap plating of the surface of the conductive metal interconnects.

8. The post-electroless plating cleaning method according to claim 7, wherein the scrub cleaning is carried out by scrubbing the substrate with a cleaning member which is parallel with the substrate plane and/or a cleaning member rotating horizontally.

9. The post-electroless plating cleaning method according to claim 7, wherein the conductive metal interconnects are copper, copper alloy, silver, silver alloy, gold or gold alloy interconnects.

10. The post-electroless plating cleaning method according to claim 7, wherein the electroless cap plating is electroless cobalt or cobalt alloy plating, or electroless nickel or nickel alloy plating.

11. The post-electroless plating cleaning method according to claim 10, wherein the electroless cap plating is carried out with a Co—W—B plating bath, a Co—B plating bath, a Co—W—P plating bath, a Ni—B plating bath or a Ni—W—B plating bath.

12. The post-electroless plating cleaning method according to claim 7, wherein the scrub cleaning is carried out by scrubbing the substrate with a cleaning member rotating about its axe which is parallel with the substrate plane.

13. The post-electroless plating cleaning method according to claim 7, wherein the scrub cleaning is carried out by scrubbing the substrate with a cleaning member mounted to the front end of a pivot arm and rotating horizontally.

14. The post-electroless plating cleaning method according to claim 7, wherein the scrub cleaning is carried out by scrubbing the substrate with a cleaning member mounted to the front end of a pivot arm and rotating horizontally, and by jetting a liquid with ultrasonic vibration to the surface of the substrate.

15. The post-electroless plating cleaning method according to claim 7, wherein the substrate is first subjected to scrub cleaning and then subjected to solution cleaning carried out by supplying a solution to a front surface and/or a back surface of the substrate while rotating the substrate.

16. The post-electroless plating cleaning method according to claim 7, wherein the scrub cleaning uses a cleaning chemical containing one or more of a surfactant, an organic alkali and a chelating agent.

17. The post-electroless plating cleaning method according to claim 7, wherein a plating film formed by the electroless cap plating serves as a protective film for the conductive metal interconnects, and a metal residue remaining on the non-circuit pattern surface of the substrate is dissolved and removed by the solution cleaning.

18. The post-electroless plating cleaning method according to claim 17, wherein the solution cleaning uses a solution which can preferentially dissolve the interconnect material rather than the plating film.

19. The post-electroless plating cleaning method according to claim 17, wherein the solution cleaning uses an acidic solution optionally containing a chelating agent, or a solution containing a chelating agent.

20. The post-electroless plating cleaning method according to claim 16, wherein the cleaning chemical contains 0.005 to 3% by weight of a nonionic surfactant.

21. The post-electroless plating cleaning method according to claim 16, wherein the cleaning chemical contains 0.01 to 2% by weight of an organic alkali.

22. The post-electroless plating cleaning method according to claim 21, wherein the organic alkali is an ammonium hydroxide or an amine.

23. The post-electroless plating cleaning method according to claim 22, wherein the ammonium hydroxide is selected from tetramethylammonium hydroxide, tetraethylammonium hydroxide and triethylammonium hydroxide.

24. The post-electroless plating cleaning method according to claim 22, wherein the amine is an aliphatic monoamine or an aliphatic polyamine.

25. The post-electroless plating cleaning method according to claim 16, wherein the cleaning chemical contains at least 0.0001% by weight of a chelating agent.

26. The post-electroless plating cleaning method according to claim 25, wherein the chelating agent is selected from ethylenediamine tetracetic acid, ethylenediamine diacetic acid, ethylenediamine dipropionic acid, nitrilotripropionic acid, and ethylenediamine ditetrakis acid.

27. The post-electroless plating cleaning method according to claim 7, wherein the scrub cleaning uses a cleaning member made of a polyvinyl acetal having fine pores (foamed polyvinyl acetal), a nonwoven fabric settled on a polyurethane, or a foamed polyurethane.

28. A substrate cleaning apparatus comprising a combination of:
a cleaning device including a plurality of rotators for supporting and rotationally driving the periphery of a substrate to be cleaned, and a cylindrical cleaning member capable of rotating about its axe which is parallel with the substrate plane to scrub clean a to-be-cleaned surface of the substrate; and
a cleaning device including a spin chuck capable of rotating horizontally while holding the substrate, and a cleaning member mounted to the front end of a pivot arm and capable of rotating horizontally to scrub clean a to-be-cleaned surface of the substrate held by the spin chuck.

29. The substrate cleaning apparatus according to claim 28, further comprising a nozzle having an ultrasonic transducer, mounted to the front end of the pivot arm, for jetting a liquid with ultrasonic vibration to the surface of the substrate.

30. The substrate cleaning apparatus according to claim 28, wherein the cleaning device including the cylindrical cleaning members further includes a cleaning chemical supply nozzle and a pure water supply nozzle, and the cleaning device including the cleaning member mounted to the front end of the pivot arm further includes a pure water supply nozzle.

31. The substrate cleaning apparatus according to claim 28, wherein the cleaning device including the cylindrical cleaning members uses a cleaning chemical containing one or more of a surfactant, an organic alkali and a chelating agent.
